(19) United States
(12) Patent Application Publication
(10) Pub. No.: US 2019/0303460 A1
(43) Pub. Date: Oct. 3, 2019

(54) TRANSACTION-BASED PSEUDO-SCRIPT GENERATION FOR SCHEDULING AND IMPLEMENTING DATABASE SCHEMA CHANGES

(71) Applicant: CA, Inc., New York, NY (US)

(72) Inventors: Wayne Joseph Barbarek, West Chicago, IL (US); Edward Allen Kendall, Glen Ellyn, IL (US)

(21) Appl. No.: 15/938,090

(22) Filed: Mar. 28, 2018

(51) Int. Cl. G06F 17/30

(52) U.S. Cl. CPC G06F 17/30297; G06F 17/30377; G06F 17/30327

(57) ABSTRACT

Embodiments are disclosed for implementing database schema modifications. In some embodiments, pending schema object changes are determined for a first database. An object tree is generated including populating the object tree with object definition nodes for schema objects to be modified by the pending schema object changes. The object definition nodes are modified in accordance with the pending schema object changes. Based on the modified object definition nodes, single-operation transactions are sequentially generated that each correspond to one of the pending schema object changes, wherein at least two of the single-operation transactions correspond to one of the pending schema object changes. A database schema is modified including executing change statements derived from the single-operation transactions.

### BACKGROUND

The disclosure generally relates to the field of data processing, and more particularly to database management.

Databases comprise collections of data organized in accordance with a database schema comprising the logical structures such as tables used to organize the stored data. The database schema is determined by the type of database management application, typically referenced as a database management system (DBMS), implemented to organize and provide access to the database. Types of access include data queries for retrieving a selected portion of the data content maintained by the database and also include database management operations such as operations to add, remove, or modify user data. Database management operations further include operations to alter the schema-defined database structures such as by adding, removing, and modifying tables.

The schema structure of relational databases enables modification of data content without continuous corresponding modifications to pointers and links. Relational databases are generally characterized as having a data organization and access schema that is based on a relational model in which data is organized into tables. The tables comprise columns and rows and are interrelated with other tables in accordance with keys and other linking mechanisms of the schema. The DBMS of most relational databases uses Structured Query Language (SQL) as the language/standard for managing the database structure as well as for querying data content.

SQL comprises different categories of statements including data definition language (DDL) statements and data manipulation language (DML) statements. The DDL statements are utilized for creating, removing, and modifying the database structure objects (also referred to herein as schema objects) such as table spaces, tables, columns, etc. SQL further includes instruction statements, referred to as utility statements, which are included in a database modification execution script to facilitate implementation of the schema modifications. Generation and implementation of DDL and utility statements as part of a database modification operation, such as a database update, follow a convention implemented by the DBMS. The convention is, at any given time, static such that the manner of generating a database modification script in terms of both instruction composition and sequential ordering is independent of variable factors involved in the underlying database structure modification operations.

### BRIEF DESCRIPTION OF THE DRAWINGS

Embodiments of the disclosure may be better understood by referencing the accompanying drawings.

FIG. 1 is a block diagram depicting a relational database system that implements transaction-based database schema modification in accordance with some embodiments;

FIG. 2 is a block diagram illustrating a database management system that includes components for implementing transaction-based configuration and translation of database schema modification scripts in accordance with some embodiments;

FIG. 3 depicts an object tree comprising object-centric tree nodes that represent hierarchically associated schema objects that are associated with a database modification operation;

FIG. 4A is a block diagram illustrating a subsystem configured for processing object tree data to generate a pseudo-script list in accordance with some embodiments;

FIG. 4B is a block diagram depicting a subsystem configured for modifying the sequential order of single-operation transactions in a pseudo-script list and for generating change statement script in accordance with some embodiments;

FIG. 5 is a flow diagram illustrating operations and functions performed as part of modifying a database schema including configuring schema modification scripts in accordance with some embodiments;

FIG. 6 is a flow diagram depicting operations and functions performed as part of generating and modifying a schema object tree in accordance with some embodiments;

FIG. 7 is a flow diagram illustrating operations and functions performed as part of pseudo-script generation in accordance with some embodiments;

FIG. 8 is a flow diagram depicting operations and functions performed as part of pseudo-script processing including determining the composition and ordering of transactions associated with database modification operations in accordance with some embodiments; and

FIG. 9 is a block diagram depicting an example computer system that implements transaction-based database schema modification in accordance with some embodiments.

### DESCRIPTION

The description that follows includes example systems, methods, techniques, and program flows that embody aspects and embodiments of the disclosure. However, it is understood that this disclosure may be practiced without one or more of these specific details. In other instances, well-known instruction instances, protocols, structures and techniques have not been shown in detail in order not to obfuscate the description.

Introduction

A database modification system may be utilized to modify the data content and the structure (referred to herein alternately as schema) of a database. The schema components are logical entities referred to herein as schema objects and may include tablespaces, tables, columns, and indexes, for example. The database modification system may operate in conjunction with a DBMS such as a relational DBMS (RDBMS)to provide facilities for processing and responding to client database modification requests. For example, an RDBMS may be configured using program logic to implement database management requests such as requests to compare/synchronize and update databases. The database modification system implements such requests including determining the schema object changes and operations required for implementing the changes. The database modification system further determines the sequential order in which the operations are to be executed to implement the changes.

Processing strategies to implement database management operations may be determined, at least in part, by hierarchical associations/relations among database schema objects. A database client such as a client application that uses a database may send a request in the form of an update or synchronization request to update the content and structure of the database. Based on the operation(s) and the database instance specified in the request, the RDBMS identifies the content and/or components of the database to be modified. As utilized herein, the content of a database refers to the data content that is loaded to and stored in the database and excludes the structure, or schema, of the database. The database schema comprises program components, referred to herein as schema objects, that form the organizational structure utilized to organize access to the data content. For example, relational databases typically utilize a tabular schema in which a given database schema comprises one or more table spaces, tables, columns, and indexes, among other structural components.

A compare database management operation request may specify that a backup database be synchronized with a corresponding online database. Based on the compare request, the database modification system identifies the backup and online databases and performs investigative operations to determine the modifications in terms of content and structure that are to be implemented on the backup database. For example, the database modification system may be configured to access a schema object catalog, sometimes referred to as a database catalog, of both the online and backup databases to determine structural differences. Based on the determined differences, the database modification system determines a set of changes to be made to the backup database. The changes may include adding schema objects, removing schema objects, and/or modifying the attributes of extant schema objects. Once the required changes have been determined, the database modification system generates code that the system will execute to implement the changes. For structured query language (SQL) type databases, for example, the code generated to implement the changes may be in the form of data definition language (DDL) statements and supporting utility statements.

Overview

The embodiments disclosed herein describe a variety of program systems, subsystems, and components for generating and configuring the program code that is executed to modify a database and in particular database schema objects. In some embodiments, a database modification system includes an object tree generator configured to generate an object tree including hierarchically associated nodes corresponding to schema objects, referred to herein as object nodes. The object tree generator is configured to identify or otherwise determine schema object changes such as may be generated to modify a database schema. The object tree generator is further configured to apply particularly identified categories of the schema object changes to the object tree nodes by modifying object definitions and inserting change definitions that encode sequence related information associated with the underlying change operations.

The identification/determination of schema object changes includes classifying the individual changes as immediate or pending. Changes identified and classified as pending changes, alternately referred to herein as “state-dependent” changes, are changes the implementation of which are determined to be dependent on the state of the object and/or at least one other schema object. Changes identified and classified as immediate changes, alternately referred to herein as “state-independent” changes, are changes the implementations of which are independent of the state of the schema object or other schema objects. In addition to the schema object changes determined in response to a currently executing database modification cycle, pending changes include changes from a previous database modification cycle. Such pre-existing pending changes include changes determined by the object tree generator to have been recorded in a database catalog but not on the schema objects themselves.

Change determination further includes determining from a set of explicitly determined schema object changes, one or more implicit schema object changes that are automatically generated by the database modification system in response to one or more of the explicit changes. The object tree generator determines and classifies implicit changes as changes not explicitly specified among the changes being generated as part of the schema object modification script and are instead generated by the database modification system during and as part of implementing one or more explicitly specified changes.

The determined immediate and pending changes are encoded in various manners within or in association with the object nodes within the object tree. The object definition nodes contain object definitions comprising recorded attributes of schema objects that are subject to the immediate and pending schema object changes. The object tree generator modifies the object definition nodes within the object tree in accordance with changes identified as immediate (i.e., state-independent) and further generates change definitions that encode sequence information (e.g., pending, immediate) relating to the modified object definitions. The change definitions each encode a state-independent indicator, state-dependent indicator, and/or an implicit indicator for a respective one of the schema object changes.

The database modification system further includes a pseudo-script list (PSL) generator that processes the modified object definition nodes to generate a list of database modification transactions including single-operation transactions, referred to herein as a PSL. As utilized herein a single-operation transaction is an operation statement that specifies only a single operation (e.g., alter, create, drop) in association with only a single schema object. A PSL post-processor processes the sequence of single-operation transactions within the PSL to determine and implement modifications to the sequential order of the transaction entries within the PSL. The PSL post-processor determines sequence modifications based on the change definitions that describe sequence dependency information in association with the underlying change operations. A modified PSL having a modified sequence of single-operation transactions is processed to generate DBMS change statements that are executed to modify the database schema.

Example Illustrations

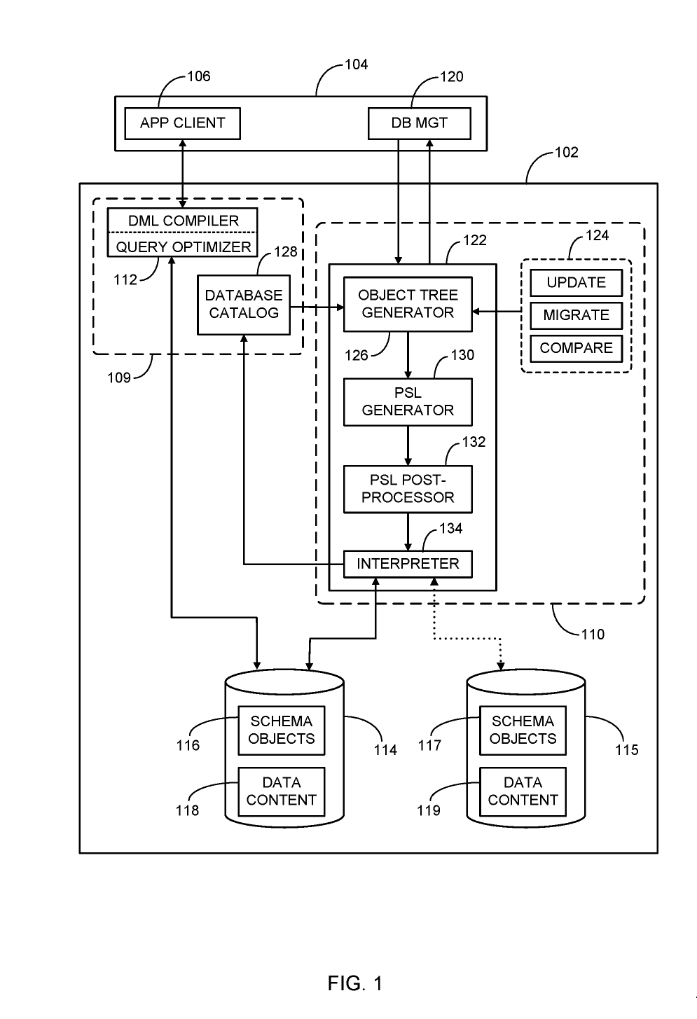

FIG. 1 is a block diagram depicting a relational database system that implements transaction-based database schema modification in accordance with some embodiments. The system includes a database host system 102 communicatively coupled to a database client node 104. Host system 102 comprises computer hardware, program logic, and data for hosting a database instance 114, which in the depicted embodiment is a relational database. Database 114 comprises a set of schema objects 116 and data content 118 that is organized and accessed in accordance with the schema implemented by the manner in which schema objects 116 are configured. The schema objects for a relational database typically include a storage group, one or more databases, tablespaces, tables, columns, and indexes, among others. Schema objects 116 are configured using a high-level DBMS language such as SQL. DB2 is an example SQL compliant RDBMS commonly used to manage relational databases such as database 114.

Host system 102 includes processing and storage hardware and system software resources for providing an execution platform for an RDBMS 109 and a database modification system 110 that clients interact with to manage, utilize, and modify database 114. RDBMS 109 is an application comprising program components for managing data query requests and database management requests from client node 104. RDBMS 109 and database modification system 110 implement a database access and management protocol that is compliant with an SQL that includes different statement categories. Two primary statement categories are data definition language (DDL) statements and data modification language (DML) statements. The DML statements are used to manipulate the data content such as data content 118 within database 114. Example DML statements include operation statements specifying operators such as CALL, INSERT, MERGE, DELETE, etc. The DDL statements are utilized for generating, removing, and modifying database schema objects such as tables. An example DDL statement may be a table alter statement ALTER TABLE FOO.

In the depicted embodiment, client node 104 is a computer system hosting a database client application 106 and a database manager application 120. During operation, database client 106 uses an SQL compliant API to communicate including transmitting query requests to a query engine 112 within RDBMS 109. Query engine 112 includes any combination of program code and data for processing query requests from database client 106 to retrieve requested portions of data content 118 from database 114. The program components within query engine 112 include a DML compiler layer and a query optimizer layer. The DML compiler translates DML SQL statements from database client 106 into low-level instructions that query engine 112 can process with respect to database 114. The query optimizer is frequently incorporated as part of the DML compiler and is configured to modify the query based on the local database configuration.

In addition to accessing database 114 to satisfy query requests, client node 104 includes a database manager application 120 configured to generate database modification requests. Database manager 120 includes program components for generating a request that specifies one or more databases to be modified and one or more operations to implement the modifications. For instance, in response to user interface input, database manager 120 may generate a database modification request in the form of a COMPARE operation that specifies a backup database instance 115 to be compared and synchronized with primary online database 114.

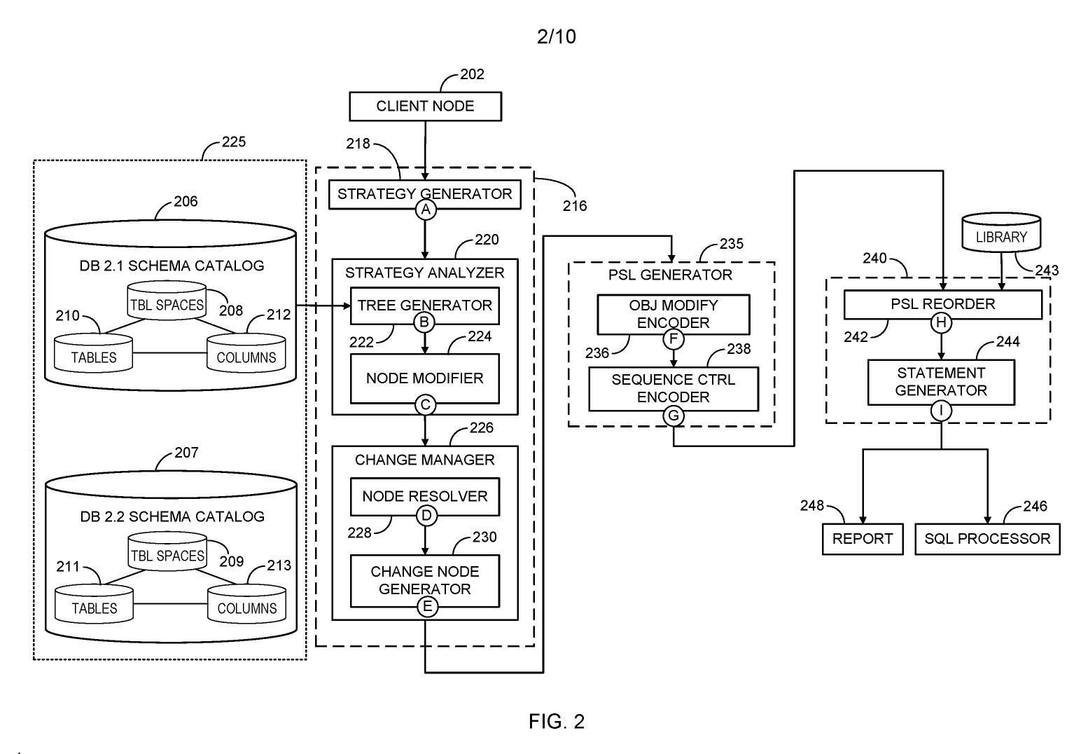

Database modification system 110 includes a schema manager 122 that is configured to process database management requests such as from database manager 120. As part of processing database management requests, schema manager 122 may implement schema changes (e.g., add/remove/modify object) in part by updating schema object definitions maintained by a database catalog 128. A database catalog, such as database catalog 128 records metadata including database schema object definitions for a particular database instance. Schema manager 122 reads and processes representations of database schema objects, referred to as object definitions, maintained within database catalog 128. The object definitions comprise schema object attribute information stored in and accessible via cross-referenced information tables depicted in further detail with reference to FIG. 2.

Schema manager 122 includes several program components including an object tree generator 126 that interfaces with database catalog 128. In response to or otherwise based on the content of a database modification request, object tree generator 126 accesses an in-memory library 124 that includes procedures for implementing each of a set of potential database modification operations required to implement a higher-level request from database manager 120. In the depicted embodiment, library 124 includes a procedure for implementing an UPDATE operation, a procedure for implementing a MIGRATE operation, and a procedure for implementing a COMPARE operation. In response to a higher-level COMPARE request, object tree generator 126 retrieves or otherwise calls the corresponding COMPARE procedure from library 124.

The COMPARE procedure is conceptually represented in FIG. 1 as a box that includes one or more program operations for determining the database schema changes that are required to implement the higher-level request. For example, object tree generator 126 may execute the COMPARE procedure, based on the constituent procedure operations and the arguments (e.g., database ID) in the higher-level request, including determining and comparing the respective content of database 114 and database 115. Object tree generator 126 generates an object tree comprising object definition nodes corresponding to schema objects of the database to be modified. Based on determined differences in the database structure/schema, object tree generator 126 modifies the object definitions and generates change definitions that may specify sequence related information for implementing the changes to the schema objects.

The schema object modifications (changes) and change definitions are constituted in accordance with the object modification protocol implemented by RDBMS 109. The object modification protocol of some DBMS's renders some object changes immediate and some pending. The object modification protocol may also include automatically generating some schema object changes (implicit changes) as part of executing explicitly generated schema object change statements. For example, an explicit change statement for modifying a schema object (e.g., column) may require a corresponding change to a parent schema object (e.g., table) that is automatically executed with the change statement is executed. As utilized herein, such corresponding change operations that are operationally associated with explicit change statements and subsequently generated are referred to herein as implicit changes.

Having determined a set of schema object changes including explicit and implicit changes (collectively schema object changes) to be implemented, object tree generator 126 further determines which of the schema object changes are pending changes and which are immediate changes. Immediate changes are those changes that are to be recorded in the database catalog and implemented on the subject schema objects in a current database modification cycle. Pending changes are changes that are either pre-existing pending changes or virtual pending changes. Pre-existing pending changes are those changes that are recorded in database catalog 128 but have not yet been implemented on the actual schema objects. Virtual pending changes are those changes that are at least initially determined as being generated or otherwise implemented by RDBMS 110 in a subsequent database modification cycle.

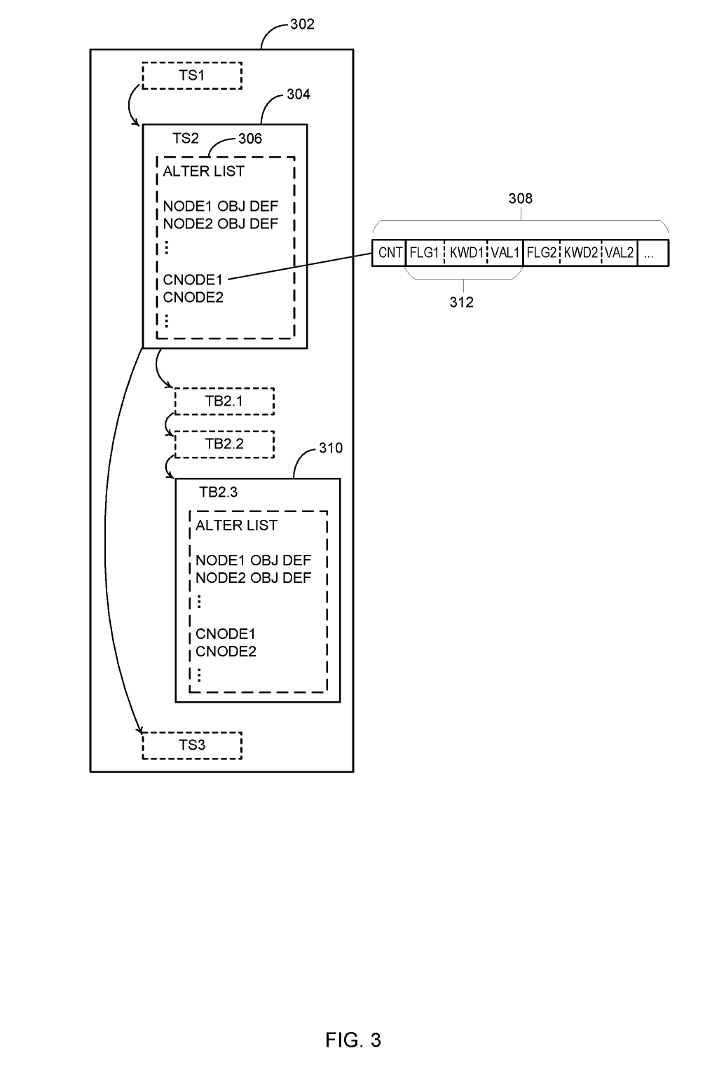

Object tree generator 126 is further configured to generate an object tree into which information regarding immediate changes, pre-existing pending changes, and virtual pending changes is encoded. As depicted and described in further detail with reference to FIGS. 2 and 3, the object tree comprises multiple hierarchically associated nodes, referred to herein as object definition nodes. Object tree generator 126 generates the object tree in part by recording definitions comprising object attributes for the schema objects specified by the determined schema object changes. Object tree generator 126 encodes the hierarchical relations among the schema objects within the object tree. In some embodiments, the hierarchical relations among schema objects are based on the categorization or typing of schema objects wherein each different category/type resides at a different hierarchical level. For example, a DB2 DBMS schema defines a schema object hierarchy in which “table” type objects reside on one level, “column” type objects reside at a lower level, etc.

Having initially generated the tree from the requisite schema object definition/description information from database catalog 128, object tree generator 126 modifies the object definition nodes in accordance with the determined immediate and pending schema object changes. In one aspect, object tree generator 126 modifies object attributes for schema object definitions in accordance with the determined immediate object changes. For example, in response to an immediate change specifying that an attribute of a column within a table is to be modified, object tree generator 126 modifies the corresponding column object definition within the object node corresponding to the column.

In accordance with the DBMS protocol, explicit changes, whether immediate or pending, are those changes for which change statements will be generated prior to execution of the changes statements to implement the modifications. In contrast, pre-execution change statements are not generated for the implicit changes. As part of object node modification, object tree generator 126 encodes information regarding whether the changes are implicit or explicit.

Schema manager 122 includes a pseudo-script list (PSL) generator 130 that is configured using any combination of program constructs and data to derive a finer instruction granularity using an intermediate format (referred to herein as pseudo-script). More specifically, PSL generator 130 is configured to generate a list of single-operation transactions for implementing the schema object changes indicated by the differences between the original unmodified object nodes in the object tree and the nodes as modified. PSL generator 130 receives and processes the component object nodes within the object tree in an order corresponding to the hierarchical associations among the nodes.

In some embodiments, PSL generator 130 processes the object nodes in a sequential order determined by the linked order among the nodes. For a DB2 DBMS, the nodes are linked by highest order object types such that the processing begins with a node corresponding to a schema object at a highest hierarchical level. Processing continues in the sequence between the highest-level object nodes until all nodes at the highest level have been processed. Once all nodes at a given level have been processed, the linked sequence continues with the next highest hierarchical level of object nodes. As depicted and described in further detail with reference to FIGS. 2-9, the object node processing by PSL generator 130 entails generating single-operation transaction statements (referred to herein as single-operation transactions) that each correspond to only one of the immediate or pending changes. PSL generator 130 further generates transactions corresponding to each detected attribute difference for each of the modified objects. As utilized herein, a single-operation transaction can specify at most one schema attribute modification. PSL generator 130 processes each of the object nodes in sequence, generating one or more single-operation transaction entries in the PSL until all nodes have been processed. The single-operation transaction entries may be recorded in the PSL in a variety of possible sequential orders. In one embodiment, the entries are recorded in the sequential order in which the object definition nodes are read and otherwise processed.

The resultant PSL comprises a list of single-operation transactions including object alter transactions and sequence control transactions. Object alter transactions specify operations that modify the database schema in some manner such as by modifying an attribute of a schema object. Sequence control transactions specify utility operations for modifying the manner in which a sequence of executable statements, such as DDL statements, are processed to implement schema modifications. The sequence control transactions may include object regeneration indicators that are also recorded in the list in a sequence corresponding to the order in which the object definition nodes are processed (i.e., the order in which the PSL entries are originally arranged).

An object regeneration indicator is a flag or other indicator that indicates the need for a specified schema object to be regenerated and that may impact the sequence in which pending changes are executed on the schema objects. In DB2, for example, a REORG utility statement is used to regenerate an object such as a table space in accordance with the DBMS object handling convention. A DB2 advisory REORG (AREO*) state indicates that an object may, based on other database schema changes, require that a REORG be performed. In response to reading a AREO* statement for an object, DB2 places the object in a suspend state in which the object and lower-order objects associated with the object cannot be modified until the pending state terminates (e.g., via REORG of the object). For example, if the pending changes include placing a table space TS1 in an AERO* state, the pending changes for lower-order objects such as tables and columns within TS1 cannot be executed until the AERO* state is cleared.

PSL generator 130 accounts for sequence control statements such as object regeneration operation statements by inserting sequence control indicators in sequence within the object alter transactions in the PSL. For example, during processing of the object nodes, PSL generator 130 may determine, based on a particular set of one or more object changes and the governing DBMS object modification protocol, that a sequence control operation is required. In response, PSL generator 130 inserts a corresponding sequence control indicator as the next in-sequence entry in the PSL.

After generation of the PSL, a PSL post-processor 132 processes the PSL to re-order the sequence of the single-operation transactions within the list. PSL post-processor 132 is configured to determine and implement the particular sequence modifications. In some embodiments, PSL post-processor 132 determines the modifications based on the content of the single-operation transactions and the sequence of the transactions in the list in combination with the object modification sequence protocol of the DBMS. PSL post-processor 132 reads the list of single-operation transactions to identify and correlate transactions that modify the same schema objects and schema objects that are hierarchically associated. For instance, PSL post-processor 132 may determine that two of the single-operation transactions are table modification transactions for a table, TB1, within a tablespace, TS1. PSL post-processor 132 may further determine that preceding the table modification transactions, the PSL includes a transaction specifying that TS1 be placed in an AREO* suspend state. Based on determining the relative sequence in which the AREO* transaction precedes the table modification transactions, PSL post-processor 132 is configured to determine a re-order in which the AREO* transaction is to be recorded subsequent to table modification transactions in the re-ordered list.

In addition to components for re-ordering the PSL, PSL post-processor 132 may include program components for generating change statements from the re-ordered PSL. In some embodiments, PSL post-processor 132 generates changes statements, including DDL and associated utility statements, in an execution sequence corresponding to the re-ordered list of single-operation transactions in the PSL. PSL post-processor 132 records or otherwise outputs the change statements in a sequence-determined series that is then received and processed by an interpreter 134 for execution. In some embodiments, interpreter 134 is an SQL interpreter that executes the change statements to implement the schema modifications on the schema objects stored within backup database 115. In addition or alternatively, the SQL interpreter may reorder the transactions to avoid the object being set into an advisory reorg pending state or having to perform one or more additional reorg operations.

FIG. 2 is a block diagram illustrating a system that includes components for implementing transaction-based configuration of database schema modification scripts in accordance with some embodiments. The system includes a client node 202 that is configured using any combination of hardware and program code to transact database modification operations. The system further includes an object tree generator 216, a PSL generator 235, and a PSL post-processor 240 that are configured to execute operations and functions for modifying a database schema such as in response to a database modification request from client node 202. To this end, object tree generator 216, PSL generator 235, and PSL post-processor 240 may include some or all of the components and performs some or all of the operations and functions described with reference to FIG. 1.

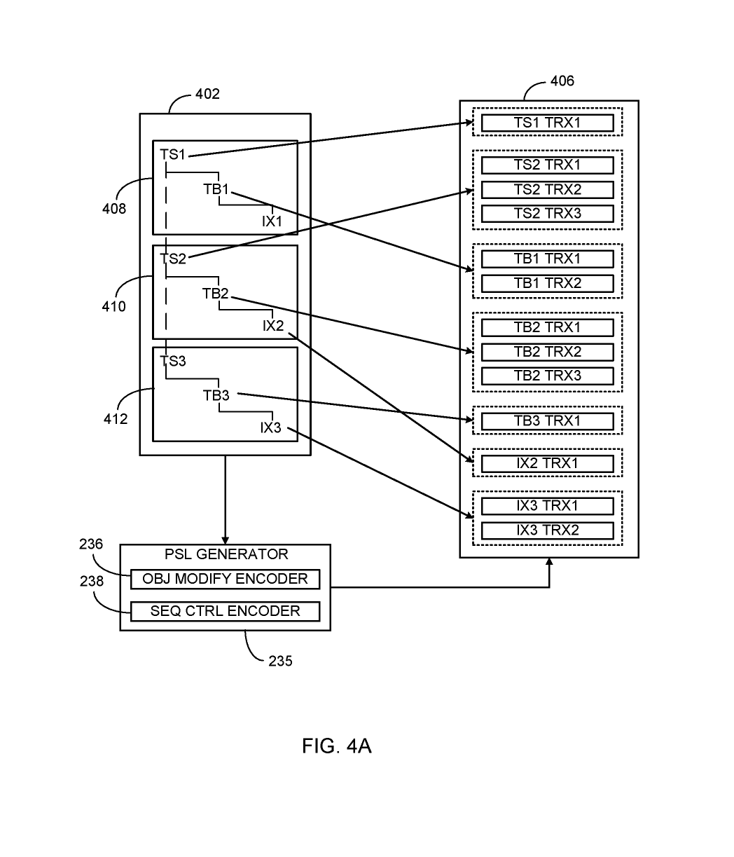

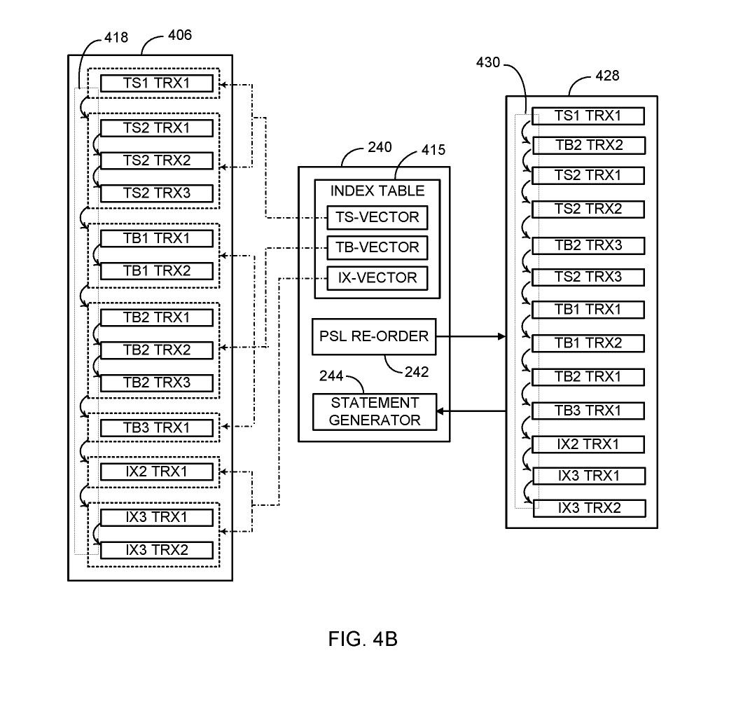

Object tree processor 216 includes program components and data for generating and processing an object tree, such as object tree 302 illustrated and described with reference to FIG. 3. PSL generator 235 and PSL post-processor 240 include program components and data for processing the output from object tree processor 216 to generate and re-configure a PSL such as depicted and described with reference to FIGS. 4A and 4B. The components of object tree processor 216 include a strategy generator 218, a strategy analyzer 220, and a change manager 226. Strategy generator 218 processes a database modification request from client node 202 to generate a set of one or more database schema changes required to implement the request. Strategy analyzer 220 comprises program components for generating an object tree comprising object nodes for schema objects including objects to be modified by the schema object changes. Strategy analyzer 220 further includes components for modifying and otherwise processing the content of the object nodes, including object definitions, in accordance with the database schema changes to determine the manner in which the schema object changes will be implemented with respect to a database catalog 206 for a database DB 2.1 within a memory space 225 maintained by a host DBMS.

PSL generator 235 is configured to generate, based on determined differences between the original unmodified nodes and the modified form of the nodes (modified object definition nodes), a form of transaction log, referred to herein as a PSL. As explained with reference to FIG. 1, the PSL comprises a serialized list of single-operation transactions some of which are derived from the modified object definition nodes and some of which comprise DBMS utility transactions. PSL post-processor 240 processes the PSL to generate a re-ordered PSL in which the relative order (e.g., serially sequential order) of single-operations transactions including schema modification transactions and sequence control transactions is modified. The re-ordering(s), are determined based on the transaction content, the original sequence of the transactions within the PSL, and operational sequences specified by an object modification protocol of the system.

FIG. 2 is annotated with a series of letters A-I that represent stages of operations performed as part of a database modification cycle as is now described. Although these stages are ordered for this example, the stages illustrate one example to aid in understanding this disclosure and should not be used to limit the claims. Subject matter falling within the scope of the claims can vary with respect to the order and function of the operations. A database modification cycle begins at stage A, with strategy generator 218 determining changes to be applied to schema objects, such as tablespace and tables within database DB 2.1. The changes determination is executed in response to or otherwise based on a database modification request in the form of a COMPARE request in which DB 2.1 is to be compared and synchronized with a database DB 2.2.

In response to the request, strategy generator 218 reads object descriptions/definitions within an in-memory instance of database catalog 206. The object definitions are maintained in indexed catalog tables including table 208 that contains tablespace definition information, table 210 that contains table definition information, and table 212 that includes column definition information. In further response to the request, strategy generator 218 retrieves an in-memory instance of a database catalog 207 for database DB 2.2. Database catalog 207 includes a table 209 that contains tablespace definition information, a table 211 that contains table definition information, and a table 213 that includes column definition information.

Strategy generator 218 compares the schema object content of DB 2.1 with the schema object content of DB 2.2 by comparing the content of database catalog 206 with the content of database catalog 207. For example, strategy generator 218 may compare table definition information including table identifier (ID) information and table attribute information in table 210 with corresponding information within table definition table 211. Strategy generator 218 determines schema object modifications based on both the request type (COMPARE and SYNC) and the content of one or both of DB 2.1 and DB 2.2. For this example, the schema object changes are determined by first determining required schema modifications such as adding and removing objects and/or modifying attributes of schema objects. Based on the requested operation, COMPARE with SYNC, strategy generator 218 identifies schema objects to be added, removed, and/or modified and further determines the manner in which any added objects are to be constructed and any attribute modifications to be implemented. For each of these changes, strategy generator 218 generates an object modification description statement in accordance with the native DBMS object modification protocol. The changes determined by strategy generator 218 may include active versioning changes. For example, to modify a cloned table, the clone must first be dropped so that modifications can be made.

The determined schema object changes include immediate changes and pending changes. Immediate changes are those changes that are to be recorded in the database catalog and applied to the schema objects during a current database modification cycle. Pending changes include pre-existing pending changes and virtual pending changes. Pre-existing pending changes are those changes that are determined to have been applied to schema object definitions as recorded in the database catalog but not yet applied to the schema objects. Virtual pending changes are those changes that have not yet been recorded in the database catalog and are determined by strategy generator 220 to be generated during execution of change statements generated during a current database modification cycle. In this manner, strategy generator in effect determines that a virtual pending change is not be applied to the schema object during a current database modification cycle.

The determination of schema object changes further includes determining for the immediate and pending changes, which are explicit or implicit changes. An explicit schema object change comprises an object modification description statement (including object alter, add, or remove) that is generated in accordance with the object modification protocol to modify at least one schema object. Implicit schema object changes are changes that are operationally associated with explicit schema object changes but for which corresponding executable change statements are not initially generated. Instead, in accordance with the object modification protocol, executable change statements such as DDL statements for implementing the implicit schema object changes are generated as part of the execution of the corresponding explicit schema object changes.

The immediate, pending, explicit, and implicit changes are processed at stage B by a tree generator 222 within strategy analyzer 220. Tree generator 222 is configured to generate an object tree object (referred to herein a schema object tree or object tree) including populating the object tree with object nodes for schema objects to be modified by the schema object changes. FIG. 3 depicts an example object tree 302 comprising object-centric tree nodes and representing hierarchically associated schema objects. The nodes within object tree 302 comprise hierarchically related object nodes that each include object definitions.

With reference to FIG. 2 in conjunction with FIG. 3, tree generator 222 initially generates object tree 302 to include the hierarchically related object nodes containing object definitions. Among the object nodes are three tablespace nodes TS1, TS2 304, and TS3 that are mutually associated by list pointers. Tablespace node 304 is hierarchically associated via a child list pointer to table object definition nodes TB 2.1, TB 2.2, and TB 2.3 310, which themselves are serially associated within the same hierarchical level. As shown, tablespace node 304 includes an alter list 306 comprising object definitions including NODE1 OBJ DEF and NODE2 OBJ DEF. This list of object definitions includes definitions/descriptions of attributes for table TS2 that may or may not be modified in accordance with immediate and/or pending changes in change node definitions that may be encoded by a node modifier 224. Similarly, in the object tree initially generated by tree generator 222, table node 310 includes multiple object attribute definitions/descriptions. Strategy analyzer 220 includes a node modifier 224 that is configured to modify the object nodes within object tree 302 in accordance with the immediate and pending object changes. At stage C, node modifier 224 modifies the object nodes by modifying one or more of the object attribute definitions of the schema objects specified by changes determined to be immediate changes. As a result, object tree 302 includes the unmodified and modified versions of the definitions of the objects to be modified.

Object tree 302 is further processed by a node resolver 228 and a change node generator 230 within change manager 226. Node resolver 228 is configured to process the modified and unmodified object nodes over one or more cycles to determine the existence and type of pending changes to be implemented on schema objects corresponding to the object definition nodes. At stage D, node resolver 228 determines for each of the nodes whether the corresponding schema object is to be modified by a pre-existing pending change or a virtual pending change. Node resolver 228 further determines, in accordance with the object modification protocol, whether the attribute modifications of the pending changes are to be applied to the schema object directly or whether the modifications require that the schema object first be dropped and subsequently regenerated.

At stage E, change node generator 230 further modifies the object tree by inserting change definition nodes associated with the pre-existing and virtual pending changes. Change node generator 230 generates and inserts the change nodes based on the attribute modification determinations made by node resolver 228. The change nodes include encoded information such as high-level instructions that specify operations required for implementing the object attribute modifications in accordance with the DBMS object modification protocol. Change node generator 224 generates changes nodes within each of the object definition nodes for which attributes of the corresponding schema object are to be modified.

With reference to FIG. 3 in conjunction with FIG. 2, change node generator 230 generates change definition nodes including CNODE1 308 and CNODE2 within alter list 306. Similarly, change node generator 230 generates multiple change definition nodes within an alter list in table node 310. CNODE1 308 is a record data structure comprising one or more attribute modification fields. Each of the attribute modification fields includes a flag entry, a keyword entry, and a value entry. For example, an attribute modification field 312 includes a flag entry, FLG1, a keyword entry, KWD1, and a value entry, VAL1. In some embodiments, the FLG1 entry may contain a flag that indicates whether or not the operation defined in the VAL1 entry is pursuant to or otherwise associated with an immediate or a virtual pending change and/or is associated with an explicit or implicit change.

At stages F and G, following processing of the object tree by change manager 226, a schema modify encoder 236 and a sequence control encoder 238 within PSL generator 235 process the modified object tree to generate a PSL. Schema modify encoder 236 reads and processes the object nodes including comparing the modified object definitions with the unmodified definitions for the same objects. Schema modify encoder 236 further reads and processes the change definition nodes. The nodes in the object tree are read and processes in a serially sequential order corresponding to the hierarchical order of the corresponding schema objects. Object modify encoder 236 includes program components for parsing the object tree to identify the change definition nodes and to log corresponding single-operation transactions for the immediate changes and pending changes. Sequence control encoder 238 includes program components for parsing the object tree to identify inserted sequence control indicators and to log corresponding single-operation transactions in the form of utility statements.

Continuing with stages F and G, FIG. 4A is a conceptual diagram illustrating an example object tree 402 that is processed by PSL generator 235 to generate a PSL 406 in accordance with some embodiments. Object tree 402 includes object nodes 408, 410, and 412 that may be configured similar to the configuration of the modified object tree 302 in FIG. 3. As shown, node 408 includes a tablespace node for TS1, node 410 includes a tablespace node for TS2, and node 412 includes a tablespace node for TS3. Each of nodes 408, 410, and 412 is a compound node, conceptually depicted as a single box and comprising multiple nodes including the tablespace nodes at a highest-order. In this example, the sub-nodes include table nodes and index nodes. For example, tablespace node TS2 is shown as being hierarchically associated with lower-order nodes TB2, which are shown as hierarchically associated with lower-order nodes IX2. The singularly depicted table and index nodes (e.g., TB1, TB2, IX3) represent one or more such object definition nodes so that, for example, TB2 may represent two table definition nodes TB2.1 and TB2.2.

Schema modify encoder 236 reads and processes the nodes within object tree 402 in hierarchical order and generates and records the corresponding single-operation transactions in the same order within PSL 406. Schema modify encoder 236 first reads the three tablespace nodes TS1, TS2, and TS3, beginning in this example with TS1 and continuing with TS2, etc. Schema modify encoder 236 parses each node to identify inserted or otherwise associated change definition nodes and records corresponding single-operation transactions. Sequence control encoder 238 parses each node to identify inserted sequence control indicators such as object regeneration indicators and records corresponding sequence control operations as single-operation transactions within PSL 406. In FIG. 4A, each single-operation transaction comprises a single a PSL node within PSL 406. FIG. 4A depicts each of the sets of single-operation transaction nodes for each schema object as corresponding individual boxes (e.g., single-operation transaction nodes TB2 TRX1, TB2 TRX2, and TB2 TRX3 for the individual attribute changes and utility statements for table TB2).

The resulting PSL 406 is received and processed by PSL post-processor 240 to generate a re-configured PSL from which a series of optimally configured change statements (object changes and utility statements) are produced. At stage H, and with reference to FIG. 4B in conjunction with FIG. 2, a PSL re-order unit 242 receives and reads the single-operation transactions within PSL 406. As depicted in FIG. 4B, the single-operation transactions are recorded in a serially sequential order within the data object (e.g., file) represented by PSL 406 and linked via a secondary chain 418. Secondary chain 418 comprise inter-transaction links some of which are depicted as pointers between the object-specific sets of one or more single-operation transactions. PSL post-processor 240 uses an index table 415 to index the transaction entries within PSL 406 based on secondary chain 418. At stage H, PSL re-order unit 242 determines modifications to the transaction sequence of PSL 406. PSL re-order unit 242 determines the modifications based on the content of the single-operation transactions, the ordering of the transactions within secondary chain 418, and the object modification protocol of DBMS 204. In some embodiments, PSL re-order unit 242 accesses a library 243 that contains object modification protocol rules applied by PSL re-order unit 242 to determine the sequence modifications.

Continuing with stage H, PSL re-order unit 242 re-orders the transactions within PSL 406 by implementing the modifications to the PSL sequence to generate a re-ordered PSL 428. As shown, the sequence re-order includes modifying the sequential order of PSL 406 so that the single-operation transaction TB2 TRX2 is inserted within re-ordered PSL 428 at a processing sequence position preceding the TS2 TRX1 transaction for tablespace TS2. The sequence re-order further includes modifying the sequential order of PSL 406 so that the transaction TB2 TRX3 is inserted within re-ordered PSL 428 at a processing sequence position preceding the TS2 TRX3 transaction for tablespace TS2.

In some embodiments, PSL re-order unit 242 may be configured to process explicit changes and implicit changes in order to convert implicit changes, including implicitly created schema objects, to explicit changes, including explicitly created schema objects. For example, the original PSL may include a table create transaction for a DBMS protocol that implicitly creates a tablespace. In this case, PSL re-order unit 242 may be configured to recognize, based on the implicit change and the associated schema object type (tablespace) that the implicit change is to be converted to an explicit change having DBMS attribute modification options similar to other explicit changes. Conversely, PSL-re-order unit 242 may be configured to process explicit changes and implicit changes in order to convert explicit changes, including explicitly created schema objects, to implicit changes, including implicitly created schema objects.

At stage I, a statement generator 244 generates change statements from the single-operation transactions in the re-ordered PSL 428. The resultant sequence of changes statements are sent to a report unit 248 as well as to an SQL processor 246 that executes the change statements to implement modifications to the schema objects. In some embodiments, the change statements may be imported to object tree processor 216 to regenerate the object tree based on the change statements. In such cases, the PSL generation and re-ordering operations are repeated for the re-generated tree and such cycles may be repeated as many times as required.

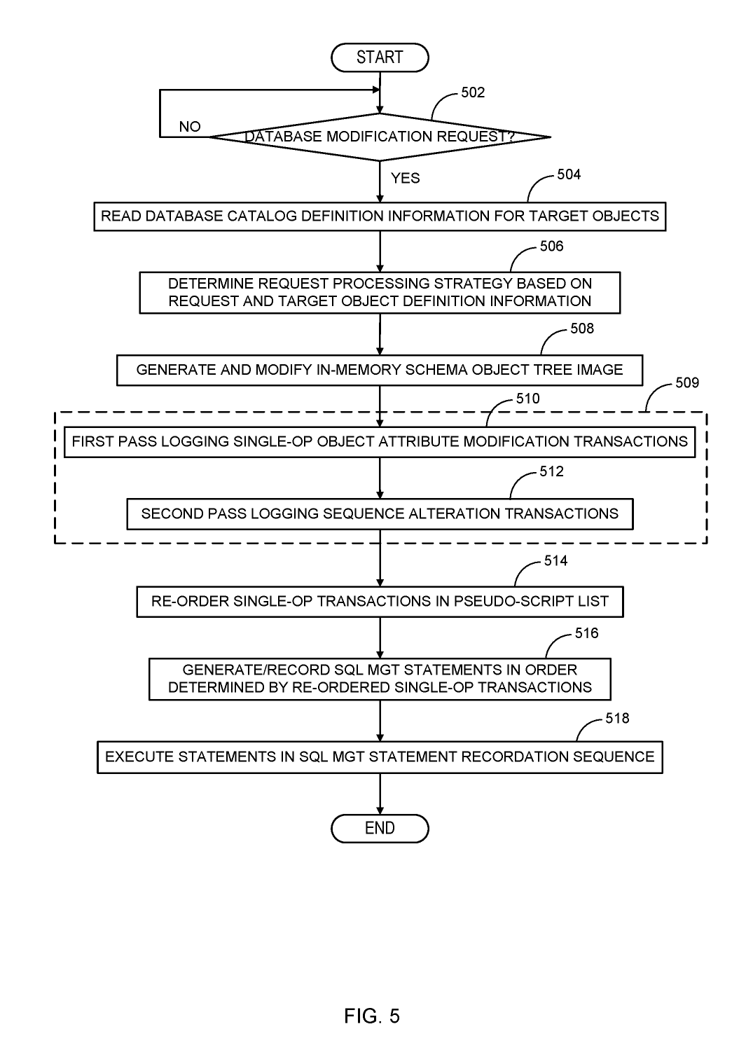

FIG. 5 is a flow diagram illustrating operations and functions performed as part of modifying a database including configuring schema modification scripts in accordance with some embodiments. The operations and functions depicted and described with reference to FIG. 5 may be implemented by one or more of the components described with reference to FIGS. 1-4. The process begins as shown at block 502 with a database management system detecting or otherwise acquiring and reading a database modification request. In response to the database modification request at block 504, an object tree processor accesses a database catalog to read object definition information for schema objects associated with the request. The object tree processor may include a strategy generator that reads the object definition information and generates a request processing strategy based on the request and the object information (block 506).

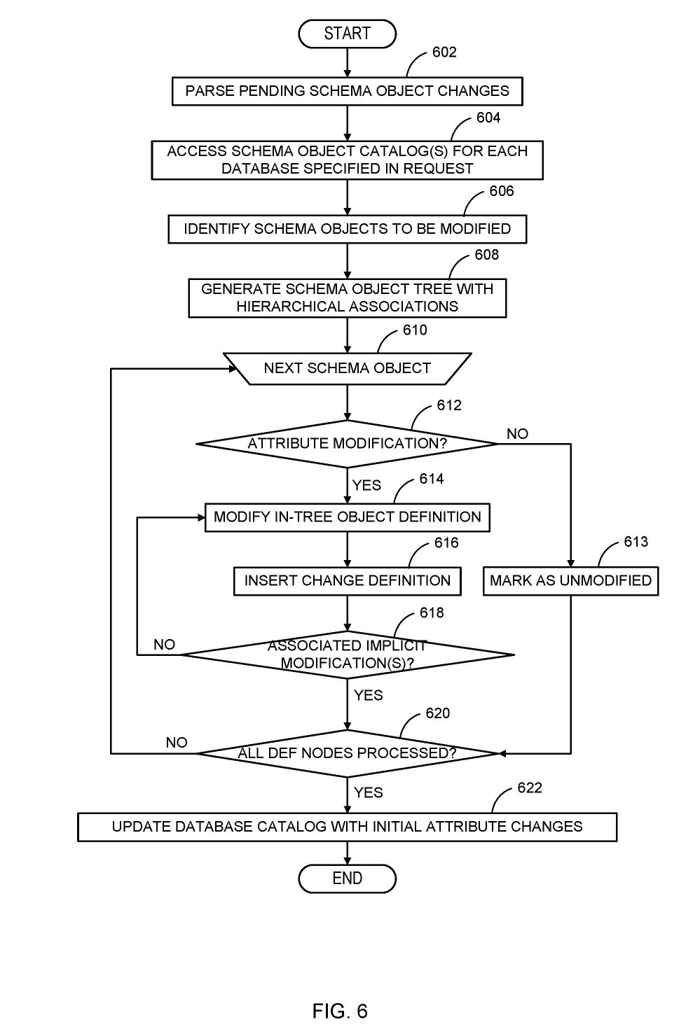

At block 508, tree generator and node modifier components within the object tree processor generate and modify an object tree as explained in further detail with reference to FIG. 6. The modified schema object tree is then processed by a PSL generator at superblock 509. First, at block 510, the PSL generator executes a first pass of the modified object tree nodes to log or otherwise generate and record single-operation transactions that modify schema object attributes. At block 512, the PSL generator executes a second pass of the object tree nodes, generating and recording single-operation transactions that each comprise sequential control operations. In some embodiments, the processing at blocks 510 and 512 may be repeated over multiple cycles.

The generated PSL is then processed by a PSL post-processor to modify the sequence in which the PSL transactions are recorded (block 514). Next, at block 516, the PSL post-processor processes the re-ordered PSL to generate a sequence of change statements and utility statements that are executed to modify the schema objects. The process ends at block 518 with a change statement processor, such as an SQL interpreter processing the series of change statements to modify the schema objects. The operations and functions depicted and described in FIG. 5 are not exclusive of additional operations and/or rearrangement of the operations or subsets of the operations. The operations may be performed as functionally separate processes at different times. For example, the modified PSLs and generated scripts may be scheduled and executed at different points in time. The generated scripts may be inspected, edited, and/or diagnosed before committing to pseudo (e.g., test) or run-time execution that optimizes the changes into the database.

FIG. 6 is a flow diagram depicting operations and functions performed as part of generating and modifying a schema object tree in accordance with some embodiments. The operations and functions depicted and described with reference to FIG. 6 may be implemented by one or more of the components described with reference to FIGS. 1-5. The process begins as shown at block 602 with a strategy generator, such as strategy generator 218 in FIG. 2, parsing database changes such as may be specified by change description statements. The parsing results in the strategy generator determining the identities of the one or more databases associated with modifications specified by a database modification request.

Based on the database ID, the strategy generator accesses corresponding object catalogs to read definition/description information for schema objects associated with the modification request (block 604). Based on the object definition/description information in combination with the modification request, the strategy generator identifies or otherwise determines the schema objects that are to be modified (block 606). Control passes from the strategy generator to a tree generator at block 608 with the tree generator generating an object tree having a hierarchically associated node structure that corresponds to DBMS defined hierarchical associations among the nodes.

The object tree comprising hierarchically associated object definition nodes is then passed to a node modifier, such as node modifier 224 in FIG. 2. Each object definition node corresponding to a schema object is processed in a modification sequence that begins at block 610. A next object definition node is read by the node modifier to determine, at block 612, whether or not one or more of the schema object changes specify a modification to an attribute of the corresponding schema object. If not, the node modifier asserts an unmodified indicator within the object definition node at block 613 after which control passes to block 620 to begin a next cycle by determining whether an additional node remains unprocessed.

If, as determined at block 612, an attribute of the corresponding schema object is to be modified, the node modifier modifies the object definition within the node accordingly (block 614). At block 616, the node modifier generates and inserts a change definition that describes procedural aspects of the change such as whether or not the change is an explicit or implicit pending change and/or whether the change is an immediate change, an existing pending change, or a virtual pending change. For an explicit pending change, the node modifier determines based on the native DBMS object modification protocol, whether an implicit object modification is associated with the pending change (block 618). If so, control returns to block 614 with the node modifier modifying the object definition node to include a change node that identifies the change as an implicit change.

At block 620, the node modifier determines whether or not all of the definition nodes have been processed. If not, control passes back to block 610 to commence a next modification cycle. Otherwise, the object tree modification process ends at block 622 with the node modifier or other component within an object tree processor updating the schema object catalog with object attribute changes marked as initial pending changes.

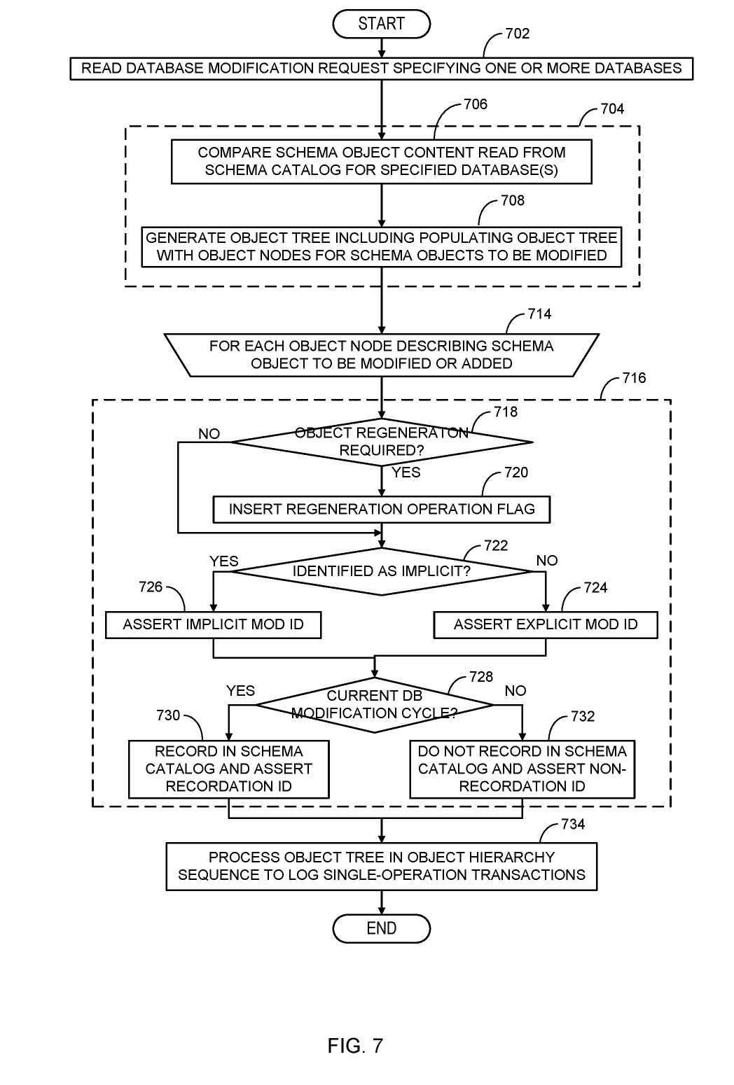

FIG. 7 is a flow diagram illustrating operations and functions performed as part of pseudo-script generation in accordance with some embodiments. The operations and functions depicted and described with reference to FIG. 7 may be implemented by one or more of the components described with reference to FIGS. 1-6. The process begins as shown at block 702 with a database modification component reading a database modification request that specifies one or more databases. Control passes to superblock 704 at which, based on the operation(s) and database(s) specified in the request, strategy generator and analyzer components generate and analyze object changes required to implement the request.

At block 706, the strategy generator compares schema object content read from database catalogs corresponding to the database(s) specified in the request. At block 708, a tree generator generates an object tree including populating the tree with object definition nodes for schema objects that will be modified and schema objects that may not be modified. Included among the object definition nodes are definition nodes corresponding to schema objects to be modified in accordance with the immediate and pending object changes. Control passes to a tree node modification sequence that is implemented for each object definition node beginning at block 714 and continuing with superblock 716 at which one or more of each of the individual nodes are modified. At block 718, a node modifier determines, based on the object modification protocol, whether or not object regeneration is required for the schema object corresponding to the object definition node. If not, control passes to block 722. Otherwise, in response to determining at block 718 that object regeneration is required, node modifier asserts/inserts a regeneration operation flag within the object definition node.

At block 722, the node modifier determines whether or not the one or more pending changes for the schema object corresponding to the node are identified as implicit changes. If not, the node modifier asserts an explicit modifier indicator within the definition node at block 724. Otherwise, in response to determining that one or more of the pending changes are implicit, the node modifier asserts/inserts implicit indicator flags in association with each such pending change (block 726). At block 728, the node modifier determines whether or not the pending changes associated with the definition node are to be executed during a current database modification cycle or are to be generated but not executed by the DBMS during a current cycle and executed subsequently.

In response to determining that the pending change will be currently executed, the node modifier records the corresponding object attribute modifications to the database catalog at block 730. Also in response to the initial execution determination, the node modifier asserts a recordation indicator within the definition node indicating that the changes have been applied to the object definitions within the catalog. In response to determining that the pending change will be subsequently executed, the node modifier asserts a non-recordation indicator within the definition node indicating that the changes have not been applied to the object definitions (block 732). The PSL generation process concludes at block 734 with a PSL generator processing the modified nodes in the modified object tree in a sequence corresponding to the DBMS object hierarchy and logs single-operation transactions comprising or otherwise derived from the pending schema object changes.

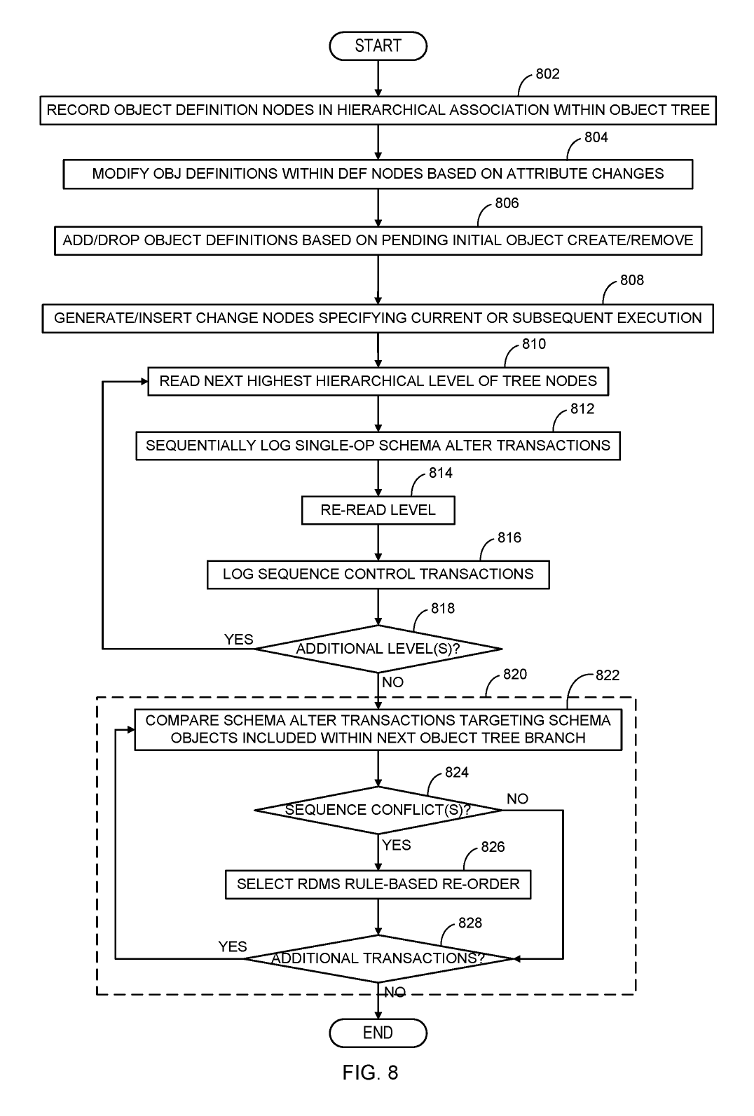

FIG. 8 is a flow diagram depicting operations and functions performed as part of pseudo-script processing including determining the composition and ordering of transactions associated with database modification operations in accordance with some embodiments. The operations and functions depicted and described with reference to FIG. 8 may be implemented by one or more of the components described with reference to FIGS. 1-7. The process begins as shown at block 802 with a tree generator generating an object tree including recording hierarchically associated object definition nodes. A node modifier modifies object definitions (e.g., attribute settings) within the definition nodes based on a set of determined schema object changes (block 804). At block 806, the node modifier further modifies the nodes by adding or dropping schema object definitions from the definition nodes in accordance with object create and object remove changes. At block 808, the node modifier further modifies nodes by generating/inserting changes nodes that specify for each change, whether the change is an immediate change a preexisting pending change or a virtual pending change that will not be recorded in the database catalog and applied to a schema object until a subsequent modification cycle.

The modified object tree is then processed by a PSL generator such as PSL generator 235 in FIG. 2. At block 810, the PSL generator reads a next highest order level of tree nodes within the hierarchical tree structure. In the same sequence as the tree nodes are read, at block 812 the PSL generator sequentially logs single-operation transactions that modify attributes of schema objects (referred to herein as object alter transactions). The PSL generator performs an additional read pass over the PSL transactions to identify and log, in sequence, sequence control transactions such as object regeneration operations (blocks 814 and 816). At block 818, in response to the PSL generator determining that an addition hierarchical level remains to be processed, control passes back to block 810 for processing of the next lowest hierarchical level.

Once all levels of the tree have been processed, the initial PSL has been generated and control passes to superblock 820 which includes multiple operations performed by a PSL post-processor. At block 822, the PSL post-processor compares object alter transactions (e.g., alter table) that specify schema objects within a next branch of the object tree. The PSL post-processor then determines at block 824, based on the operations themselves, the current relative sequence of the transaction within the PSL, and the DBMS object modification protocol whether the current relative sequence presents any sequence conflicts. If no sequence conflicts are identified, control passes to block 828 with the PSL post-processor determining whether additional transactions remain unprocessed by the operations within block 822. In response to identifying sequence conflicts within the nodes of the current object tree branch, the PSL post-processor selects or otherwise determines a re-ordering of one or more of the nodes within the PSL (block 826). The process continues at block 828, with the process ending in response to the PSL post-processor determining that all transactions have been processed.

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality provided as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may be developed in a variety of development environments such as integrated development environments and using tools such as a software development kit (SDK). The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

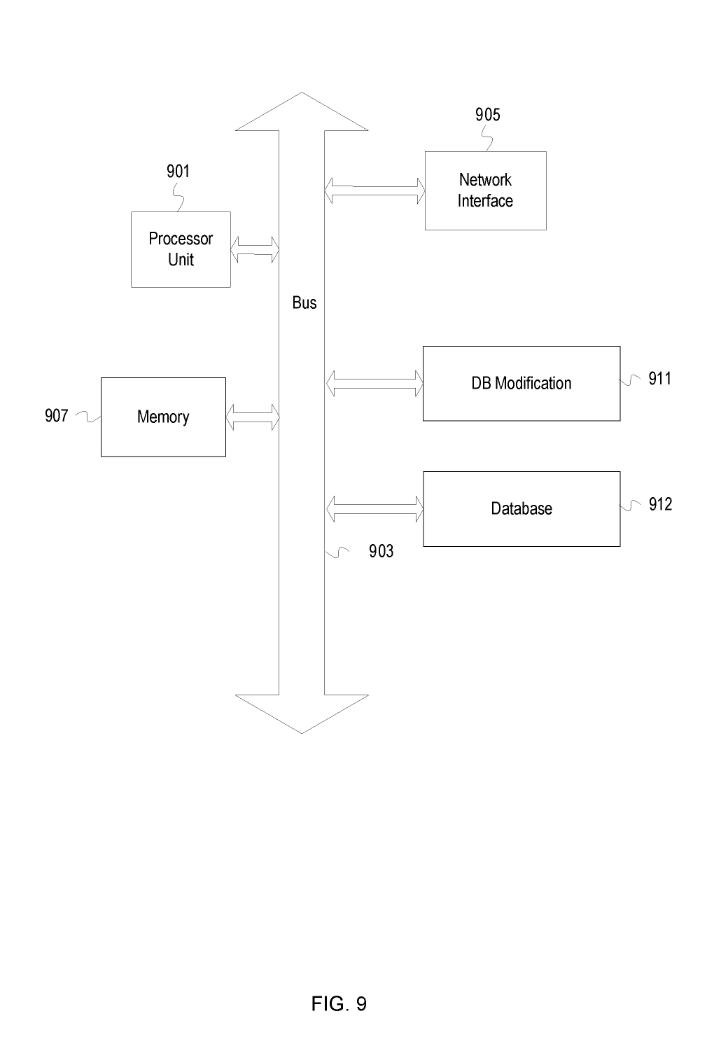

FIG. 9 depicts an example computer system that implements database schema modification in accordance with some embodiments. The computer system includes a processor unit 901 (possibly including multiple processors, multiple cores, multiple nodes, and/or implementing multi-threading, etc.). The computer system includes memory 907. The memory 907 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 903 (e.g., PCI, ISA, PCI-Express, HyperTransport® bus, InfiniBand® bus, NuBus, etc.) and a network interface 905 (e.g., a Fiber Channel interface, an Ethernet interface, an internet small computer system interface, SONET interface, wireless interface, etc.). The system also includes a database 912 and a database modification system 911 such as may incorporate the systems, devices, and components depicted and described with reference to FIGS. 1-8. The database modification system 911 provides program structures for generating and configuring a PSL and executing change statement from the re-ordered PSL as described with reference to FIGS. 1-8. To this end, the database modification system 911 may incorporate and/or utilize some or all of the system, devices, components, and data structures described in FIGS. 1-8.

Any one of the previously described functionalities may be partially (or entirely) implemented in hardware and/or on the processor unit 901. For example, the functionality may be implemented with an application specific integrated circuit, in logic implemented in the processor unit 901, in a co-processor on a peripheral device or card, etc. Further, realizations may include fewer or additional components not illustrated in FIG. 9 (e.g., video cards, audio cards, additional network interfaces, peripheral devices, etc.). The processor unit 901 and the network interface 905 are coupled to the bus 903. Although illustrated as being coupled to the bus 903, the memory 907 may be coupled to the processor unit 901.

While the aspects of the disclosure are described with reference to various implementations and exploitations, it will be understood that these aspects are illustrative and that the scope of the claims is not limited to them. In general, techniques for integrating data sources as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality shown as separate components in the example configurations may be implemented as a combined structure or component. Similarly, structures and functionality shown as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method comprising:
determining, based on a database modification request, a set of schema object changes for schema objects of the database;
generating an object tree including generating hierarchically related object nodes that each include an object definition from a database catalog for a respective one of the schema objects;
determining that one or more of the schema object changes are pending changes;
modifying the object nodes, including, for a first set of the object nodes corresponding to schema objects specified by the pending changes, generating change definitions that specify whether each of the pending changes is to be implemented in a current or a subsequent database modification cycle; and
generating, based on the modified object nodes, a list of database modification transactions.

2. The method of claim 1, wherein said generating the list of database modification transactions further comprises generating, based at least in part on the change definitions, single-operation transactions each corresponding to one of the pending changes and that indicate whether the pending change is a pending change that will be executed in a current or a subsequent database modification cycle.

3. The method of claim 2, wherein said determining that one or more of the schema object changes are pending changes comprises determining from a database catalog pending list record that a schema object change has been recorded in the database catalog, said generating single-operation transactions comprising generating a single-operation transaction corresponding to the schema object change that has been recorded in the database catalog.

4. The method of claim 2, wherein said determining that one or more of the schema object changes are pending changes comprises determining, based on a database management object modification protocol, that a schema object change specifies a schema object that will be placed in a modification-pending suspended state by a database management system.

5. The method of claim 4, wherein said generating single-operation transactions comprises generating a single-operation transaction corresponding to the schema object change that specifies a schema object that will be placed in a modification-pending suspended state by the database management system, and wherein the generated single-operation transaction indicates the modification-pending suspended state.

6. The method of claim 1, wherein at least two of the database modification transactions are derived from one of the schema object changes.

7. The method of claim 1, wherein the database modification transactions comprise object alter transactions and sequence control transactions, and wherein the list of database modification transactions is generated in a first sequence, said method further comprising:
determining, based on the database modification transactions, the first sequence, and an operation sequence specified by an object modification protocol of a database management system, modifications to the first sequence;
re-ordering the list of database modification transactions by implementing the determined modifications to the first sequence to generate a re-ordered list of single-operation transactions;
generating change statements from the database modification transactions in an execution sequence corresponding to the re-ordered list of single-operation transactions; and
executing the change statements in the execution sequence to modify the database schema.

8. The method of claim 1, further comprising:
determining whether one or more of the schema object changes are immediate changes; and
wherein said modifying the object nodes further includes, for a second set of the object nodes corresponding to schema objects specified by the immediate changes, modifying the object definitions based on the immediate changes.

9. The method of claim 8, wherein said determining that one or more of the schema object changes are immediate changes comprises, for each schema object change that is not recorded in the database catalog, determining that the schema object change is to be implemented in the current database modification cycle.

10. The method of claim 1, wherein said determining a set of schema object changes includes:
determining explicit changes derived from the database modification request; and
determining implicit changes that are automatically generated by a database management object modification protocol based on one or more of the explicit schema object changes.

11. The method of claim 10, wherein said modifying the object nodes further comprises including generating change definitions that include implicit change identifiers that are associated within the change definitions with the explicit object changes.

12. The method of claim 10, wherein said generating the list of database modification transactions includes generating a respective single-operation transaction for each of the explicit and implicit object changes.

13. The method of claim 10, further comprising converting at least one of the determined explicit changes to an implicit change.

14. The method of claim 10, further comprising converting at least one of the determined implicit changes to an explicit change.

15. One or more non-transitory machine-readable media comprising program code for modifying a database, the program code to:
determine, based on a database modification request, a set of schema object changes for schema objects of the database;
generate an object tree including generating hierarchically related object nodes that each include an object definition from a database catalog for a respective one of the schema objects;
determine that one or more of the schema object changes are pending changes;
modify the object nodes, including, for a first set of the object nodes corresponding to schema objects specified by the pending changes, generating change definitions that specify whether each of the pending changes is to be implemented in a current or a subsequent database modification cycle; and
generate, based on the modified object nodes, a list of database modification transactions.

16. The machine-readable media of claim 15, wherein the program code to generate the list of database modification transactions further comprises program code to generate, based at least in part on the change definitions, single-operation transactions each corresponding to one of the pending changes and that indicate whether the pending change is a pending change that will be executed in a current or a subsequent database modification cycle.

17. The machine-readable media of claim 16, wherein the program code to determine that one or more of the schema object changes are pending changes comprises program code to determine, based on a database management object modification protocol, that a schema object change specifies a schema object that will be placed in a modification-pending suspended state by a database management system, and wherein the program code to generate single-operation transactions comprises program code to generate a single-operation transaction corresponding to the schema object change that specifies a schema object that will be placed in a modification-pending suspended state by the database management system, and wherein the generated single-operation transaction indicates the modification-pending suspended state.

18. An apparatus comprising:
a processor; and
a machine-readable medium having program code executable by the processor to cause the apparatus to,
determine, based on a database modification request, a set of schema object changes for schema objects of the database;
generate an object tree including generating hierarchically related object nodes that each include an object definition from a database catalog for a respective one of the schema objects;
determine that one or more of the schema object changes are pending changes;
modify the object nodes, including, for a first set of the object nodes corresponding to schema objects specified by the pending changes, generating change definitions that specify whether each of the pending changes is to be implemented in a current or a subsequent database modification cycle; and
generate, based on the modified object nodes, a list of database modification transactions.

19. The apparatus of claim 18, wherein the program code to cause the apparatus to generate the list of database modification transactions further comprises program code to cause the apparatus to generate, based at least in part on the change definitions, single-operation transactions each corresponding to one of the pending changes and that indicate whether the pending change is a pending change that will be executed in a current or a subsequent database modification cycle.

20. The apparatus of claim 19, wherein the program code to cause the apparatus to determine that one or more of the schema object changes are pending changes comprises program code to cause the apparatus to determine, based on a database management object modification protocol, that a schema object change specifies a schema object that will be placed in a modification-pending suspended state by a database management system, and wherein the program code to cause the apparatus to generate single-operation transactions comprises program code to cause the apparatus to generate a single-operation transaction corresponding to the schema object change that specifies a schema object that will be placed in a modification-pending suspended state by the database management system, and wherein the generated single-operation transaction indicates the modification-pending suspended state.
